(19) United States
(12) Patent Application Publication
(10) Pub. No.: US 2015/0022634 A1
(43) Pub. Date: Jan. 22, 2015

(54) OBJECT INSPECTION SYSTEM

(71) Applicant: The Steelastic Company LLC, Akron, OH (US)

(72) Inventor: Jason R. Perez, Massillon, OH (US)

(73) Assignee: The Steelastic Co., LLC, Akron, OH (US)

(21) Appl. No.: 13/943,527

(22) Filed: Jul. 16, 2013

(51) Int. Cl. G06T 7/00; G01B 11/02

(52) U.S. Cl. CPC G06T 7/0004; G01B 11/022
USPC 348/46

(57) ABSTRACT

An inspection system is provided that includes at least one three-dimensional camera that is used to inspect an object to determine whether the object contains any defects. The defects that are capable of being detected by the inspection system include holes, tears, and improper thickness, and overlap. The inspection system is configured to alert a user in the event that the object contains a defect.

### BACKGROUND

The present embodiments relate generally to a system for inspecting an object using a three dimensional camera.

Tire belt formation is a well-known practice that involves pulling multiple cords through an extrusion die. The extruder heats elastomeric material and coats the cords traveling through the die. Cooling drums adjacent to the extruder act both to pull the cords through the die and cool the fiber reinforced material before the cutting and splicing phase of production. After traveling through the cooling drums, the fiber reinforced material is allowed to hang with some slack in order to remove some residual forces. The fiber reinforced material is then drawn onto a cutting station. The cutting station includes a strip vacuum transfer, a cutter, and a belt conveyor. The strip vacuum transfer advances the fiber reinforced strip and positions it on the belt conveyor so that the cutter may cut the fiber reinforced material. The belt conveyor then indexes a predetermined distance. The strip vacuum transfer again advances the strip onto the conveyor so that the cutter again cuts it. This process results in a continuous belt of fiber reinforced material with the reinforcing cords lying at some angle typically not parallel to the central axis of the belt.

Defects can occur during the tire belt formation process that could potentially render the product unusable. For example, the tire belt formation process may result in a tire belt that contains holes or tears or has an improper thickness, width, or splice. To minimize or prevent these and other common defects from occurring, inspection systems are used to inspect the product. Traditional systems rely on a two-dimensional camera to inspect the tire belt for defects. These traditional two-dimensional camera systems require a strong backlight or front light to enable the two-dimensional camera to detect certain defects, such as holes and tears. The light illuminates the inspection area and illuminates defects such as holes that pass entirely through the product.

The two-dimensional camera, by its definition, is unable to detect defects that do not result in the complete penetration of the product because it is unable to detect differences in thickness. In other words, the two-dimensional camera system is limited in its ability to detect variances in height and depth that are not detectable on the X and Y-axes. It is for at least this reason that a better, improved inspection system is needed to identify defects that are not detectable using a traditional two-dimensional camera inspection system.

### SUMMARY

One embodiment of the present invention includes an inspection system having a roller assembly having a rolling surface, a first three-dimensional camera adjacent to the roller assembly and configured to measure an object on the rolling surface, a laser disposed adjacent to the first three-dimensional camera, the laser configured to project a laser beam on the rolling surface, and a monitoring system in communication with the first three-dimensional camera, where the monitoring system compares the measurement obtained from the first three-dimensional camera to a parameter.

Other embodiments of the present invention further provide for a second three-dimensional camera that is disposed adjacent to the first three-dimensional camera, the first three-dimensional camera is disposed above the rolling surface, and where the laser forms part of the first three-dimensional camera, is separate from the first three-dimensional camera and is disposed between the first three-dimensional camera and the second three-dimensional camera; where the first three-dimensional camera and the second three-dimensional camera are configured to measure the width, offset, and thickness of an object and are configured to detect any holes, whether through holes or not, in an object; and where the monitoring system further comprises an alarm that notifies a user if the measurement from the first three-dimensional camera exceeds a certain parameter.

Yet another embodiment of the present invention includes an inspection system having a roller assembly having a rolling surface, first and second three-dimensional cameras adjacent to the roller assembly and configured to measure an object on the rolling surface, a laser disposed between the first and second three-dimensional cameras, the laser configured to project a laser beam on the rolling surface, and a monitoring system in communication with the first three-dimensional camera, the monitoring system configured to compare a measurement from the first three-dimensional camera to a parameter.

Other embodiments of the present invention include the first and second three-dimensional cameras being disposed above the rolling surface; the measurement of an object that can include the thickness, width, and offset of the object; where the laser is configured to illuminate a portion of the object that is being monitored by the first and second lasers; and where the laser is independent from the first and second three-dimensional cameras.

One method of using one of the embodiments of the present invention for inspecting an object includes providing a roller assembly having a rolling surface, a first three-dimensional camera adjacent to the roller assembly, and a laser disposed adjacent to the first three-dimensional camera, placing the object on the rolling surface of the roller assembly, projecting a laser beam on a surface of the object, rotating the roller surface, measuring the object with the first three-dimensional camera, communicating the measurement to a monitoring system, and comparing the measurement to a parameter.

The method may further include providing a second three-dimensional camera with the first three-dimensional camera, measuring the object that includes inspecting the object for any holes where measuring the object includes measuring the width, offset, and thickness of the object, notifying a user if a measurement of the object is outside of a parameter, and inputting a parameter into an inspection system.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a perspective view of an inspection system of one embodiment of the present invention.

FIG. 2 is a front view of the inspection system shown in FIG. 1.

FIG. 3 is a perspective view of the laser used to inspect an object using the inspection system of FIG. 1.

FIG. 4 is a partial schematic of an inspection software, encoder, and cameras used for the inspection system shown in FIG. 1.

FIG. 5 is a perspective view of a tire belt making system that may employ the inspection system shown in FIG. 1.

FIG. 6 is an operational flow chart depicting an exemplary inspection procedure.

FIG. 7 is a partial front view of the inspection system shown in FIG. 1 and a calibration system.

### DETAILED DESCRIPTION OF THE PREFERRED EMBODIMENTS

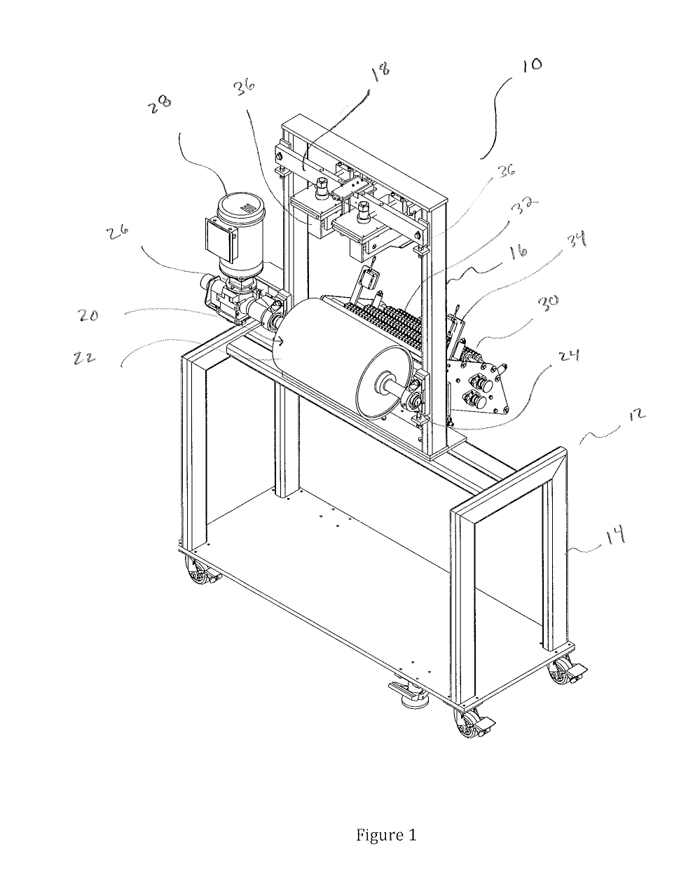

Referring to FIGS. 1-7, an inspection system is generally indicated by numeral 10. The inspection system 10 may be used in any tire belt making system or any other system where defects can exist. One example of such a tire belt making system can be found in U.S. Pat. No. 7,497,241, the disclosure of which is incorporated herein by reference in its entirety. In the tire belt making system disclosed by the '241 patent, the inspection system 10 is located after the bias cutter. However, this is only exemplarily in nature, and it can be appreciated that the system 10 can be configured to be placed in any desirable location and can be used to inspect any other object that may have surface defects, such as sheets made out of polymers, metals, other composite materials, and the like.

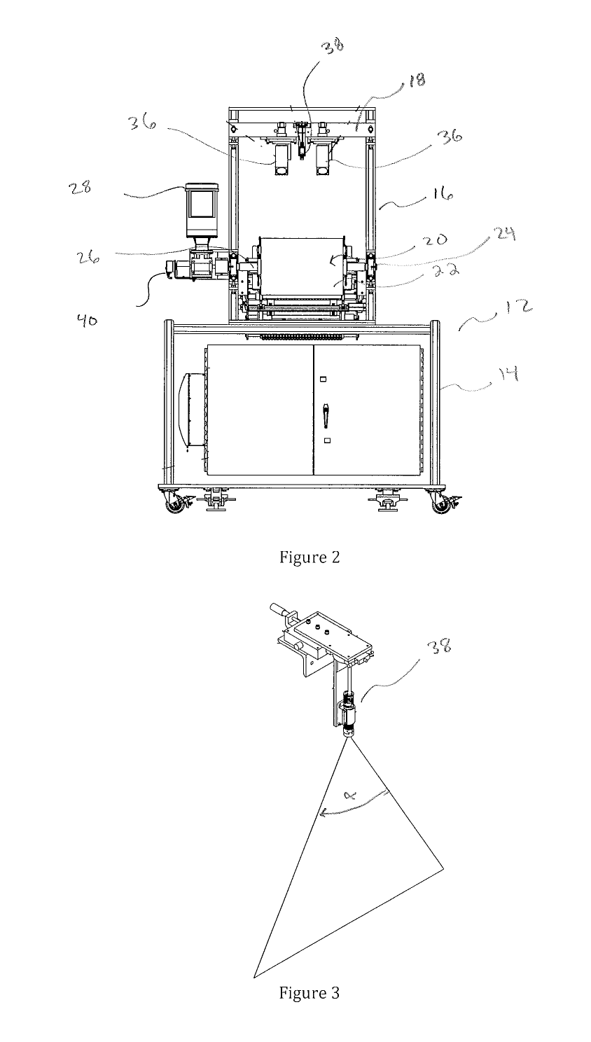

As shown in FIGS. 1 and 2, the inspection system 10 includes a frame 12 having a bottom frame portion 14 connected to a top frame portion 16. The top frame portion 16 includes a top cross-member 18. Disposed within the frame is a drum 20. The drum 20 includes a rolling surface 22 and has a first end 24 and a second end 26 that are rotatably connected to the frame 12. This allows the drum 20 to rotate within the frame 12 during the inspection process.

A motor 28 is configured to impart a rotational force on the drum 20 to allow the drum 20 to rotate within the frame 12. The rotation of the drum 20 translates an object that is placed along the rolling surface 22 from one side of the frame 12 to the other and along to another device. It can be appreciated that the drum 20 may also consist of one or more miniature rollers to accomplish the same task of moving the object relative to the frame 12. The speed of the drum 20 can be controlled by the PLC and loop photo-eyes.

A feeding track 30, as shown in FIG. 1, may also be used to orientate the object, which in this embodiment is a tire belt, prior to coming in contact with the drum 20. The feeding track 30 can consist of a series of rollers 32 and two alignment arms 34 to align the tire belt to ensure that it is properly orientated on the rolling surface 22 for the inspection process.

As shown in FIG. 2, coupled to the cross member 18 are two three-dimensional cameras 36. The three-dimensional cameras 36 are positioned over the drum 20, and specifically the rolling surface 22, so as to inspect the object as it is being passed over the rolling surface 22 beneath the cameras 36. The drum 20 may be calibrated so that it is completely level and perpendicular to the inspection field of the three-dimensional cameras 36. The three-dimensional cameras 36 can measure various parameters of the object, such as its height, thickness (i.e. elevation), and depth in order to detect deformities within the object that is being manufactured or inspected. For example, the three-dimensional cameras 36 can measure parameters such as belt width, belt thickness, offset splice (i.e. dog ears), open splices, splice overlap, and splice thickness of a tire belt during the various stages of the manufacturing process. It also can detect holes and foreign objects that may be embedded within or disposed on the tire belt. One type of three-dimensional camera 36 that can be used with this system is the Sick ICD-3D 100 camera, manufactured by SICK Inc. of Minneapolis, Minn. It can be appreciated that other three-dimensional cameras with similar functionality may be used with the present invention.

Furthermore, it can be appreciated that the location and the number of three-dimensional cameras 36 are application dependent and may vary from application to application. For example, and without limitation, there may only be one three-dimensional camera 36 or more than two, depending on the size of the object to be inspected. For example, in one embodiment used for the tire belt, if the tire belt width is less than 230 mm, only one camera may be required. Two cameras may be used for widths up to 471 mm. Of course, these width dimensions are for one particular application that is using one particular 3-D camera, and the inspection field width of the three-dimensional camera used in the system 10 may vary depending on the type of camera used.

In addition, the location of the three-dimensional cameras 36 may change depending on the orientation of the surface to be inspected. If the side or bottom surface of the object is to be inspected, then the three-dimensional cameras 36 may be disposed to the side or underneath the object, respectively.

The functionality of the three-dimensional camera 36 enables inspection of an object in a manner that is not possible by a traditional two-dimensional camera. In addition to the parameters discussed above, the three-dimensional camera 36 may also be used to detect holes, open splices, or tears within the surface of the object that do not penetrate all the way through the object. Such deformities would not be detectable by a two-dimensional camera because they are only detectable by measuring the thickness of the material about an axis that is perpendicular to the surface of the object.

A laser 38 is disposed between the two three-dimensional cameras 36 as shown in FIG. 2 and mounted on the cross member 18. The laser 38 is used to illuminate the region of the object that is being scanned or monitored by the three-dimensional cameras 36. In this embodiment, the laser 38 is aligned with the two cameras 36. However, it can be appreciated that the laser 38 may also be positioned at a different location, such as to one side of the three-dimensional cameras 36. The width of the laser projection on the object may be at least as wide as the width of the inspection field generated by the three-dimensional cameras 36. The laser 38 in this embodiment is separate and apart from the two three-dimensional cameras 36. This is because the lasers disposed within the three-dimensional cameras 36 project beams that partially overlap with one another, which results in measurement errors by the three-dimensional cameras 36. Unless the mechanical alignment of the two lasers is precise, the adjacent three-dimensional camera 36 may show a discontinuity in the overlap region.

By using a third independent laser 38, neither three-dimensional camera 36 sees an overlapped laser line. The data captured by the two three-dimensional cameras 36 from the overlap region captured by the three-dimensional cameras 36 may be manipulated such that the discontinuity is removed. Moreover, by using an independent laser 38, a “Class 2” laser may be used to accomplish the measurement of wider belts at an acceptable resolution and speed. This may not be the case with the laser within the three-dimensional camera 36 because the three-dimensional camera 36 must be farther away to “see” the entire belt width and a stronger (brighter) laser may be needed, which may require eye protection.

As shown in FIG. 3, the laser 38 has a laser beam angle a that is projected onto the object. As mentioned above, the angle a must be wide enough to cover the portion of the object that is being measured or inspected by the three-dimensional cameras 36. It can also be appreciated that more than one laser 38 may be used if there are discrete sections of the object that need to be inspected or measured such that the two laser beams do not overlap with one another.

An encoder 40, as shown in FIG. 2, may be in communication with the three-dimensional cameras 36 so as to retrieve and process the data collected from the three-dimensional cameras 36 for processing by an inspection software 42. The encoder 40 is used to clock image profiles to the camera system 36 in order to build a three-dimensional image of the belt material. This information and other related data can be recorded to log files or by a data acquisition computer.

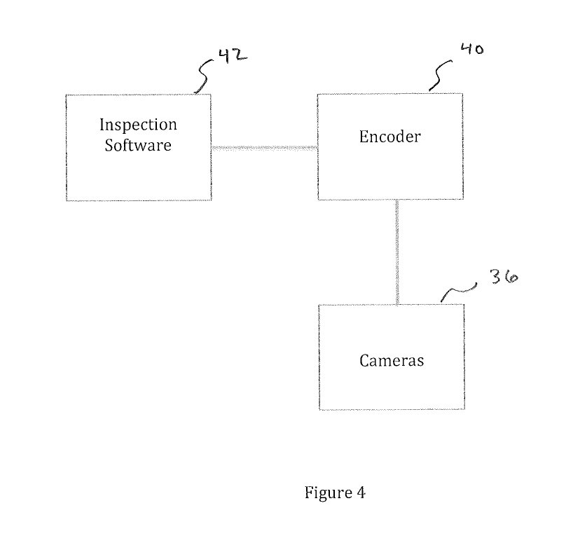

The inspection software 42, as shown in FIG. 4, is in communication with the encoder 40, which in turn is in communication with the cameras 36. It can be appreciated that the software 42, encoder 40, and cameras 36 may be entirely or partially in wireless communication with one another. It is also contemplated that the three-dimensional cameras 36 may be in direct communication with the inspection software 42.

One type of inspection software 42 that can be used with the system 10 is IVC Studio 3.2, manufactured by SICK Inc. of Minneapolis, Minn. It can be appreciated that other types of software may also be used with the inspection system 10. The inspection software 42 is designed to configure and calibrate the camera(s) to inspect or monitor the object/product and compare the characteristics of the object/product to parameters that are inputted by a user.

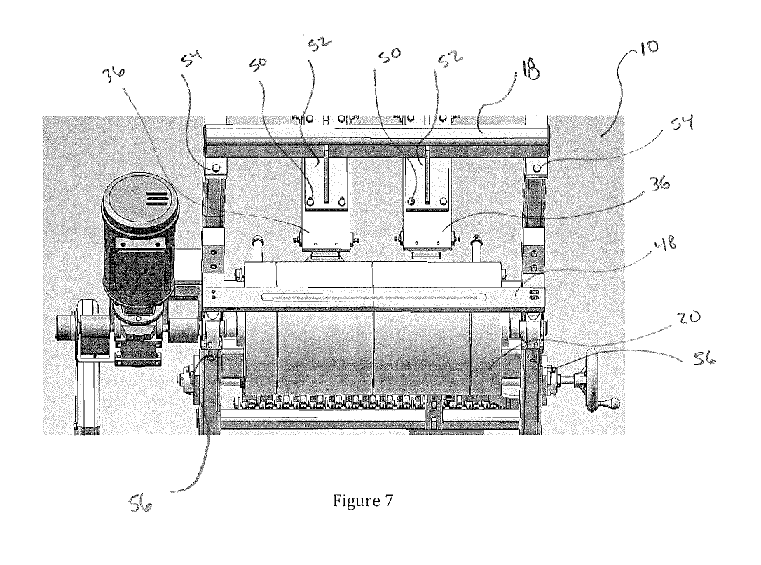

The three-dimensional cameras 36 rely on precise calibration and alignment in order to function and operate in the intended manner. The software system 42 also includes a calibration feature that enables the three-dimensional cameras 36 to be calibrated prior to use. As shown in FIG. 7, the inspection system 10 may include a calibration fixture 48 to aid in the calibration process. The calibration fixture 48 allows the inspection software 42 to calibrate the three-dimensional cameras 36 by leveling the cameras 36 using the laser beams of the three-dimensional cameras 36 with respect to the calibration fixture 48 and thus the drum 20 and rolling surface 22. Once the three-dimensional cameras 36 are leveled, the calibration fixture 48 can be flipped over such that a thin groove is showing. The inspection software 42 can then be used to align the laser beams of the cameras 36 such that they are centered inside the small groove of the calibration fixture 48. The three-dimensional cameras 36 can be adjusted using set screws 50 within the camera brackets 52 that are attached to the cross member 18. Alternatively, the cross member 18 includes slotted holes 54 that enable the entire cross member 18 to be adjusted to calibrate the three-dimensional cameras 36. The three-dimensional cameras 36 can also be calibrated to measure the overall belt width by using a calibration bar. The fixture surface is calibrated by initializing the software 42 to capture the image of the surface.

Another aspect of calibrating the three-dimensional cameras 36 includes using the lasers built into the three-dimensional cameras 36 to align them to the drum 20. To do so, the laser beams of the three-dimensional cameras 36 are aligned with the laser beam that is generated by the laser 38 in a manner such that the leaser beams of the three-dimensional cameras 36 do not overlap but are collinear with one another. Once all the beams are aligned, the laser beams of the cameras 36 are turned off while the laser 38 remains on and is used during the inspection process. In addition, and to the extent necessary, the drum 20 may also be leveled using jack screws 56. Preferably, the drum 20 is level to the cameras 36 as well such that a portion of the rotating surface 22 is perpendicular to the inspection field generated by the three-dimensional cameras 36.

Typically, as mentioned above, the inspection system 10 can be used with a tire belt making system. A discussion of one process of cutting and splicing the tire strips to manufacture a tire belt can be found in above-referenced U.S. Pat. No. 7,497,241. For example, the system 10 may be placed after the bias cutter of a tire manufacturing system. The inspection system 10 will be positioned at a location to allow it to inspect the tire strips once they have been cut and spliced together.

A discussion of the operation of the inspection system 10 in the context of inspecting a tire belt follows. However, it can be appreciated that the inspection system 10 can be used for other types of materials and the discussion below is not intended to limit the scope of the present invention.

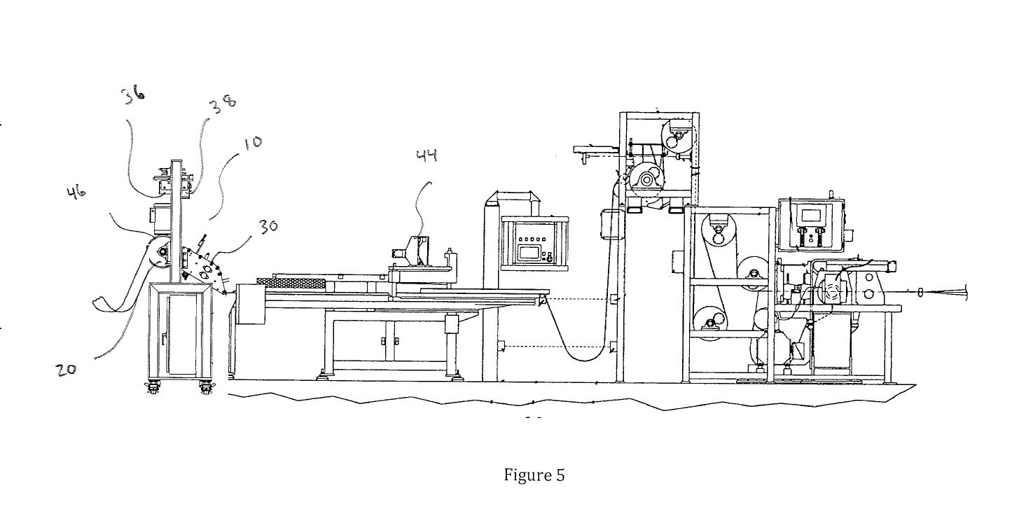

As shown in FIG. 5, the inspection system 10 is disposed after the cutter 44 in this configuration. The tire belt 46 is positioned onto the feeding track 30 and on top of the rolling surface 22 of the drum 20. The laser 38 projects a laser beam across the width of the tire belt 46 and the two three-dimensional cameras 36 inspect the illuminated portion of the tire belt 46 for any defects. Specifically, the two three-dimensional cameras 36 gather the thickness data of the tire belt 46 and combine it with the encoder feedback 40 to generate a three-dimensional image of the tire belt 46. Once the three dimensional image is generated, dimensional data of the image are compared to the user inputted parameters by the inspection software 42. As discussed above, these parameters include, but are not limited to, the belt width, splice dog-ear (i.e. offset splice), open splices, and splice thickness. In addition, the parameters may also include belt thickness to determine if there are any tears or holes in the tire belt.

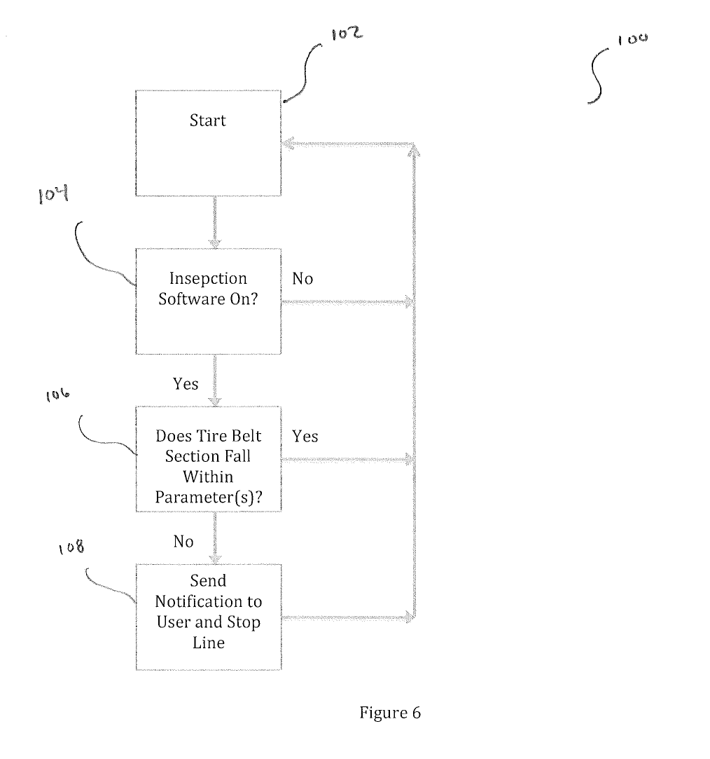

Referring now to FIG. 6, a flow chart, designated generally by the numeral 100, is representative of one embodiment of computer readable media tangibly embodying a program of instructions that could be contained in the inspection software 42 or central control unit for inspecting the tire belt 46. The method steps of the software may be programmed to any computer or machine-readable media, and performed by a suitable computer such as a control unit. The process begins when the inspection system 10 is initialized 102. The central control unit may inquire if the inspection software 42 is enabled 104. If not, the central control unit will take no further action. If the software 42 is initialized 102, it will inspect the object, which in this embodiment is the tire belt, to determine whether the inspected section falls within the user specified parameters 106. If the tire belt section 46 falls within the user specified parameters, no action is taken. If the tire belt section 46 falls outside of the specified parameter, the software 42 sends a notification to a user and a command to stop the manufacturing line 108. It can be appreciated that the parameter contemplated may be a single parameter or a host of parameters and that the command to stop the manufacturing line may occur if any one of parameters are violated or if only certain parameters are violated.

While various embodiments of the invention have been described, the invention is not to be restricted except in light of the attached claims and their equivalents. Moreover, the advantages described herein are not necessarily the only advantages of the invention and it is not necessarily expected that every embodiment of the invention will achieve all of the advantages described.

1. An inspection system, the system comprising:
an assembly having a surface;
a first three-dimensional camera adjacent to the assembly and configured to measure an object on the surface;
a laser disposed adjacent to the first three-dimensional camera, the laser configured to project a laser beam on the surface;
a monitoring system in communication with the first three-dimensional camera, where the monitoring system compares the measurement from the first three-dimensional camera to a parameter.

2. The inspection system of claim 1, wherein the laser forms part of the first three-dimensional camera.

3. The inspection system of claim 1, wherein the surface is a rolling surface.

4. The inspection system of claim 1, the system further comprising a second three-dimensional camera that is disposed adjacent to the first three-dimensional camera.

5. The inspection system of claim 4, wherein the laser is separate from the first and second three-dimensional cameras.

6. The inspection system of claim 5, wherein the laser is disposed between the first three-dimensional camera and the second three-dimensional camera.

7. The inspection system of claim 6, wherein the first three-dimensional camera and the second three-dimensional camera are configured to measure the width, offset, and thickness of an object.

8. The inspection system of claim 7, wherein the first three-dimensional camera and the second three-dimensional camera are configured detect any holes, whether through holes or not, in an object.

9. The inspection system of claim 8, wherein the monitoring system further comprises an alarm that notifies a user if the measurement from the first three-dimensional camera exceeds a parameter.

10. An inspection system, the system comprising:
an assembly having a surface;
first and second three-dimensional cameras adjacent to the assembly and configured to measure an object on the surface;
a laser disposed between the first and second three-dimensional cameras, the laser configured to project a laser beam on the surface;
a monitoring system in communication with at least the first three-dimensional camera, the monitoring system configured to compare a measurement from at least the first three-dimensional camera to a parameter.

11. The inspection system of claim 10, wherein the first and second three-dimensional cameras are disposed above the surface.

12. The inspection system of claim 11, where the measurement of an object can include the thickness, width, and offset of the object.

13. The inspection system of claim 12, wherein the laser is configured to illuminate a portion of the object that is being monitored by the first and second lasers.

14. The inspection system of claim 13, wherein the laser is independent from the first and second three-dimensional cameras.

15. A method for inspecting an object, the method comprising:
providing an assembly having a surface, a first three-dimensional camera adjacent to the assembly, and a laser disposed adjacent to the first three-dimensional camera;
placing the object on the surface of the assembly;
projecting a laser beam on a surface of the object;
measuring the surface of the object with the first three-dimensional camera;
communicating the measurement to a monitoring system; and
comparing the measurement to a parameter.

16. The method of claim 15 further comprising aligning a second three-dimensional camera with the first three-dimensional camera.

17. The method of claim 16 wherein measuring the object includes determining the thickness of a portion of the object to detect surface deformities.

18. The method of claim 16 wherein measuring the object includes measuring the width, offset, and thickness of the object.

19. The method of claim 18 further comprises notifying a user if a measurement of the object is outside of the parameter.

20. The method of claim 18 further comprising inputting a parameter into an inspection system.
